(19) United States
(12) Patent Application Publication
(10) Pub. No.: US 2014/0113057 A1
(43) Pub. Date: Apr. 24, 2014

(54) USE OF A SOY DERIVATIVE IN ASSOCIATION WITH A VEGETABLE OLEIN IN AN ANIMAL FEED

(71) Applicant: Serino Nazzaro, Milano (IT)

(72) Inventor: Serino Nazzaro, Milano (IT)

(21) Appl. No.: 14/125,085

(22) PCT Filed: Jun. 11, 2012
(86) PCT No.: PCT/IB2012/001134

§ 371 Date: Dec. 9, 2013

(30) Foreign Application Priority Data
Jun. 10, 2011 (IT) MI2011A001051
Mar. 19, 2012 (IT) MI2012A000419

(51) Int. Cl. A23K 1/16

(52) U.S. Cl. CPC A23K 1/164
USPC 426/635

(57) ABSTRACT

A method of using of a soy derivative in association with at least one vegetable olein to yield an emulsifying composition for preparation of an animal feed containing nutritive substances in liquid, powder, or granular form.

The present invention relates to the use of (a) a soy derivative in association with (b) at least one vegetable olein to yield an emulsifying composition that has use in the preparation of an animal feed containing nutritive substances in liquid, powder or granular form.

In particular, the present invention relates to the use of an emulsifying composition comprising (a) a soy derivative in association with (b) at least one vegetable olein as a technological additive to increase hourly output (tons/hour) in an animal feed production plant and/or improve the characteristics of an animal feed, preferably in the form of pellets, and/or to reduce the dustiness thereof.

In particular, the present invention relates to the use of an emulsifying composition comprising (a) a soy derivative in association with (b) at least one vegetable olein as a nutritional additive to increase the nutritional value of the feed, increase availability so as to improve the absorption, by the animals, of the individual ingredients having a nutritional value which are present in the feed, increase the animals' growth per unit of weight of feed and/or increase the animals'daily growth.

Moreover, the present invention relates to an animal feed containing an emulsifying composition comprising (a) a soy derivative in association with (b) at least one vegetable olein.

Finally, the present invention relates to a process for preparing an animal feed in which use is made of an emulsifying composition comprising (a) a soy derivative in association with (b) at least one vegetable olein.

In the field of production of animal feeds, preferably in solid form, for example in the form of pellets, a need has long been felt to be able to produce large amounts per day at increasingly lower costs while maintaining high as regards the characteristics and chemical and/or physical properties of the feed itself.

In practice, animal feed manufacturers tend on the one hand to increase the output of their plants and on the other hand to contain production costs. Maximizing the output of their plants means that animal feed manufacturers do not have to design and build new plants, while saving on production costs means being increasingly competitive. Among the factors that most greatly impact the cost of producing an animal feed we may mention, for example, the cost of the electricity needed for the equipment and the downtimes that result every time the equipment is disabled due to the activation of the equipment safety systems, which are triggered every time there is an increase in temperature due to friction during the mixing, compression and/or pelletting steps, or an excessive demand of energy from the motors present in the plant. Practically speaking, depending on the type of feed being produced in a plant, for example a feed for chickens, turkeys, pigs, ruminants or fishes, there is a considerable variation in the type of raw materials used and equipment parameters, so that “standardization of production cycles” is not always easy to achieve.

Furthermore, animal feed manufacturers have an interest in reducing the consumption of electricity and amount of dust allowed in workplaces.

Therefore, industry operators feel a need to be able to give an adequate response to the above-mentioned limits and disadvantages. Moreover, they also feel a need to be able to have an emulsifier, having nutritional purposes, for a feed capable of ensuring an adequate, healthy, safe growth of animals throughout all stages of their growth.

One of the objects of the present invention relates to increasing the hourly output (tons/hour) in plants that produce animal feeds in solid form, for example in the form of pellets, while maintaining high standards as regards the characteristics and chemical and/or physical properties of the feed itself, such as, for example, the pellet durability index (PDI).

Another object of the present invention relates to reducing or containing production costs, which means reducing electricity consumption expressed as amperes/hour.

Yet another object of the present invention relates to reducing the amount of dust produced in an animal feed in solid form, for example in the form of pellets. Another object of the present invention is to provide an animal feed which is capable of increasing the nutritional value of the feed, increasing availability so as to improve the absorption, by the animals, of the individual ingredients present in the feed, increasing the animals' growth per unit of weight of feed and/or increasing the animals' daily growth.

The Applicant has surprisingly found that the above objects, and still other objects which will be apparent from the detailed description that follows, are achieved thanks to the use of an emulsifying composition comprising (a) a soy derivative in association with (b) at least one vegetable olein.

An object of the present invention is the use of an emulsifying composition comprising or, alternatively, consisting of a soy derivative (a) selected from the group comprising or, alternatively, consisting of (a0), (a1), (a2), (a3), (a4) and/or (a5), in association with at least one vegetable olein (b) selected from the group comprising or, alternatively, consisting of the compounds (b1), (b2), (b3), (b4), (b5) and/or (b6)—hereinafter “at least one vegetable olein”, as set forth in the appended independent claim.

An object of the present invention is a feed containing an emulsifying composition comprising or, alternatively, consisting of a soy derivative (a) selected from the group comprising or, alternatively, consisting of (a0), (a1), (a2), (a3), (a4) and/or (a5), in association with at least one vegetable olein (b) selected from the group comprising or, alternatively, consisting of the compounds (b1), (b2), (b3), (b4), (b5) and/or (b6)—hereinafter “at least one vegetable olein”, as set forth in the appended independent claim.

A further object of the present invention is a process for preparing an animal feed which envisages the use of an emulsifying composition comprising or, alternatively, consisting of a soy derivative (a) selected from the group comprising or, alternatively, consisting of (a0), (a1), (a2), (a3), (a4) and/or (a5), in association with at least one vegetable olein (b) selected from the group comprising or, alternatively, consisting of the compounds (b1), (b2), (b3), (b4), (b5) and/or (b6)—hereinafter “at least one vegetable olein”, as set forth in the appended independent claim.

An object of the present invention is the use of an emulsifying composition comprising or, alternatively, consisting of:
a soy derivative (a) selected from the group comprising or, alternatively, consisting of:
   polyethylene glycol esters of fatty acids obtained from soybean oil—additive E487,
   a soybean oil,
   an ethoxylated soybean oil and/or ethoxylated soybean,
   at least one fatty acid obtained from soybean oil,
   at least one ethoxylated fatty acid obtained from soybean oil, or
   a mixture thereof; and
at least one vegetable olein (b) selected from the group comprising or, alternatively, consisting of:
   an oleic acid,
   a linoleic acid,
   a linolenic or alpha-linolenic acid,
   a monoglyceride of oleic acid and/or a diglyceride of oleic acid and/or a triglyceride of oleic acid,
   a vegetable oil or
   a mixture thereof,
      said composition being used to prepare an animal feed containing nutritive substances in liquid, powder or granular form.

Preferably, said composition comprises or, alternatively, consists of:
a soy derivative (a) selected from the group comprising or, alternatively, consisting of:
   polyethylene glycol esters of fatty acids obtained from soybean oil—additive E487,
   an ethoxylated soybean oil and/or ethoxylated soybean,
   at least one ethoxylated fatty acid obtained from soybean oil, or
   a mixture thereof; and
at least one vegetable olein (b) selected from the group comprising or, alternatively, consisting of:
   an oleic acid,
   a linoleic acid,
   a monoglyceride of oleic acid, a diglyceride of oleic acid, a triglyceride of oleic acid, or
   a mixture thereof.

Preferably, said composition comprises or, alternatively, consists of:
a soy derivative (a) selected from the group comprising or, alternatively, consisting of:
   polyethylene glycol esters of fatty acids obtained from soybean oil—additive E487,
   an ethoxylated soybean oil and/or ethoxylated soybean; and
at least one vegetable olein (b) selected from the group comprising or, alternatively, consisting of:
   an oleic acid,
   a linoleic acid, or
   a mixture thereof.

Preferably, said polyethylene glycol esters of fatty acids obtained from soybean oil—additive E487, said ethoxylated soybean oil and/or ethoxylated, soybean contain from 5 to 200 ethyleneoxy groups; preferably from 10 to 150 ethyleneoxy groups; even more preferably from 20 to 80 ethyleneoxy groups.

Preferred embodiments of the present invention will be illustrated below in the detailed description that follows.

The emulsifying composition comprises or, alternatively, consists of (a) a soy derivative selected from the group comprising or, alternatively, consisting of (a0) polyethylene glycol esters of fatty acids obtained from soybean oil—additive E487, (Community Register of Feed Additives—EU Regulation No. 1831/2003), in association with at least one vegetable olein (b). For example, the composition can comprise or consist of: (a0)+(b1); or (a0)+(b2); or (a0)+(b3); or (a0)+(b4); or (a0)+(b5); or (a0)+(b6), in a ratio by weight comprised from 1:10 to 10:1, preferably comprised from 1:5 to 5:1, for example 1:1.

The polyethylene glycol esters of fatty acids obtained from soybean oil, (additive E487—EU Regulation 1831/2003) are surfactant or emulsifying compounds included in the list of authorized animal feed additives (Common name: PEG esters of fatty acids from soya oil; EC No.: E487; Chemical Name: Polyethyleneglycol ester of fatty acids from soya oil; CAS No.: 61791-07-9).

Said esters (a0) are obtained using techniques, apparatuses and operating conditions known to the persons skilled in the art.

For example, said polyethylene glycol esters of fatty acids obtained from soybean oil, (additive E487—EU Regulation 1831/2003) can be obtained from soybean oil, for example from soybean oil triglycerides, which are hydrolyzed, using techniques and apparatuses known to the person skilled in the art, to yield saturated and/or unsaturated fatty acids of soybean oil. Subsequently, said fatty acids are ethoxylated with ethylene oxide using known techniques and apparatuses. Ethylene oxide binds to the carboxyl of the fatty acid to yield the fatty acid obtained from ethoxylated soybean oil.

For example, said polyethylene glycol esters of fatty acids obtained from soybean oil, (additive E487—EU Regulation 1831/2003) can be obtained from the reaction between a polyethylene glycol—indicated as PEG for the sake of brevity [CAS number 25322-68-3; structural formula HOCH₂—(CH₂—O—(CH₂)₍ₙ₋₁₎—CH₂OH or H—(OCH₂—(CH₂)ₙ—OH; molecular weight comprised, for example, from 100 to 10000] with the fatty acids obtained from soybean oil or with soybean oil fats or triglycerides using techniques, apparatuses and operating conditions known to the persons skilled in the art.

Preferably, the polyethylene glycol (PEG) has a molecular weight comprised from 200 to 5000.

Preferably, the polyethylene glycol has a molecular weight comprised from 300 to 4000; even more preferably from 400 to 3500.

In a preferred embodiment, the polyethylene glycol has a molecular weight comprised from 500 to 1500.

In another preferred embodiment, the polyethylene glycol has a molecular weight comprised from 600 to 1000, for example from 700 to 900.

By fatty acids obtained from soybean oil we mean one or more fatty acids obtained using the techniques, apparatuses and operating conditions known to the persons skilled in the art. For example, a soybean oil (triglyceride) can be subjected to a process of hydrolysis in water to yield glycerine and a mixture of soybean oil fatty acids.

Soybean oil (100 g) generally has the following composition: approximately 16 g of saturated fats, approximately 23 g of monounsaturated fats, approximately 58 g of polyunsaturated fats and approximately 3% of other compounds—Table A.

A soybean oil, preferably a refined soybean oil, contains, for example, the following fatty acids:
linolenic or alpha-linolenic acid (C-18:3)—CAS number 463-40-1, approximately 5 to 10%;
linoleic acid (C-18:2)—CAS number 60-33-3, approximately 50 to 60%;
oleic acid (C-18:1)—CAS number 112-80-1, approximately 18 to 25%;
stearic acid—CAS number 57-11-4, approximately 3 to 6%;
palmitic acid—CAS number 57-10-3, approximately 8 to 12%.

The polyethylene glycol esters of fatty acids obtained from the soybean oil of the present invention (additive E487—EU Regulation No. 1831/2003) can be in the form, for example, of monoesters or diesters or mixtures thereof.

In the context of the present invention and hereinafter we shall make reference in general to “polyethylene glycol esters of fatty acids obtained from soybean oil” to indicate one or more of the above-mentioned embodiments having a variable composition of soybean oil fatty acids, without any limitation but solely for the purpose of simplifying the present description.

In a preferred embodiment, the soybean oil fatty acid is selected from among linolenic or alpha-linolenic acid (C-18:3)—CAS number 463-40-1, linoleic acid (C-18:2)—CAS number 60-33-3, oleic acid (C-18:1)—CAS number 112-80-1, stearic acid—CAS number 57-11-4 and palmitic acid—CAS number 57-10-3 and mixtures thereof; in particular, the soybean oil fatty acid selected can be a mixture of linolenic acid and/or linoleic acid and/or oleic acid in a ratio by weight of 1:1:1 or 1:1:2 or 1:2:1 or 1:2:2.

In a preferred embodiment, the emulsifier comprises or, alternatively, consists of a soy derivative selected from the group comprising or, alternatively, consisting of (a1) soybean oil, in association with at least one vegetable olein (b). For example, the composition can comprise or consist of: (a1)+(b1); or (a1)+(b2); or (a1)+(b3); or (a1)+(b4); or (a1)+(b5); or (a1)+(b6), in a ratio by weight comprised from 1:10 to 10:1, preferably comprised from 1:5 to 5:1, for example 1:1.

Soybean oil is a vegetable oil extracted from soybeans (Glycine max). Soybean oil is obtained using the techniques, apparatuses and operating conditions known to the persons skilled in the art.

The composition of the soybean oil can be, for example, the following (per 100 grams): 16 grams of saturated fats, 23 grams of monounsaturated fats, 58 grams of polyunsaturated fats and 3% of other compounds. The unsaturated fatty acids in soybean oil triglycerides can be, for example, as follows: 5-10% by weight of alpha-linolenic acid (C-18:3); 50-60% by weight of linoleic acid (C-18:2); and 18-25% by weight of oleic acid (C-18:1). Moreover, saturated fatty acids, namely, stearic acid (3-6% by weight) and palmitic acid (8-12% by weight), are also present.

Saturated fat means a fat consisting of triglycerides containing solely saturated fatty acids. Saturated fatty acids have a carbon number comprised, for example, as follows: less than 6 (short-chain saturated fatty acids); from 6 to 12 (medium-chain saturated fatty acids; 13-21 (long-chain saturated fatty acids) and greater than 22 (very long-chain saturated fatty acids).

For example, a soybean oil can have the following specifications: an acidity value (amount of free fatty acids) of less than 0.5 mg KOH/g; a peroxide value no greater than 1.0 meq O₂/Kg; an iodine value comprised from 120 to 145 mg I₂/100 g and a trans fatty acid value of at most 2% by weight.

The emulsifying composition comprises or, alternatively, consists of a soy derivative selected from the group comprising or, alternatively, consisting of (a2) ethoxylated soybean oil and/or ethoxylated soybean, in a ratio by weight comprised from 1:3 to 3:1, for example 1:1, in association with at least one vegetable olein (b). For example, the composition can comprise or consist of: (a2)+(b1); or (a2)+(b2); or (a2)+(b3); or (a2)+(b4); or (a2)+(b5); (a2)+(b6); or (ethoxylated soybean oil)+(b1); or (ethoxylated soybean oil)+(b2); or (ethoxylated soybean oil)+(b3); or (ethoxylated soybean oil)+(b4); or (ethoxylated soybean oil)+(b5); (a2)+(b6); or (ethoxylated soybean)+(b1); or (ethoxylated soybean)+(b2); or (ethoxylated soybean)+(b3); or (ethoxylated soybean)+(b4); or (ethoxylated soybean)+(b5); (ethoxylated soybean)+(b6); all the above in a ratio by weight comprised from 1:10 to 10:1, preferably comprised from 1:5 to 5:1, for example 1:1.

The ethoxylated soybean oil is obtained by means of an ethoxylation process, which involves the use of ethylene oxide, carried out on the soybean oil. The ethoxylation of soybean oil is realized using procedures, chemical reactions and apparatuses known to the persons skilled in the art.

For example, an inert gas (nitrogen) is blown into a reactor in order to eliminate the presence of oxygen and subsequently a pre-established amount of soybean oil is introduced into the reactor. A profile of the fatty acids present in the soybean oil can be: C16:0 (palmitic acid) 9-13%; C18:0 (stearic acid) 3-5%; C18:1 (oleic acid) 17-30%; C18: (linoleic acid) 48-58; C18:3 (linolenic acid) 5-10%; C20:0 (arachidonic acid) less than 1%. The soybean oil is hydrolyzed to free fatty acids in the presence of an alkaline catalyst and ethylene oxide, for example at a temperature of 120-180° C. and a pressure of 0.5-6.0 bars. After the addition of ethylene oxide is completed, the reaction temperature is maintained until a constant pressure value is reached. The reaction is then cooled and the alkaline catalyst is neutralized by adding an acid. The residual ethylene oxide and 1,4-dioxane are removed by using an inert gas or high-temperature steam. Then a vacuum is generated to remove any trace of steam (stripping). When the levels of ethylene oxide and 1,4-dioxane are below 1 mg/Kg and 5 mg/Kg respectively, the reaction is cooled to below 70° C. so as to then filter the reaction product.

The degree of ethoxylation can vary according to need. For example, 10 or 20 or 40 or 65 moles of ethylene oxide can be reacted with 1 mole of fatty acids contained in the soybean oil (see patent applications GB1050497 A and EP516099 A1 incorporated herein by reference).

The ethoxylated soybean is obtained by means of an ethoxylation process carried out directly on the free saturated and/or unsaturated fatty acids. The free fatty acids are obtained by hydrolyzing the triglycerides of soybean oil. Ethoxylation is an industrial process in which ethylene oxide is added to alcohols, phenols and acids (i.e. compounds having reactive hydrogen atoms) in an amount that varies according to the operating conditions of temperature, pressure, solvent and catalyst. The ethoxylated soybean is realized using procedures, chemical reactions and apparatuses known to the persons skilled in the art.

Ethoxylation is also known by the term PEGylation because poly(ethylene oxide) is also known as poly(ethylene glycol), abbreviated PEG. Therefore, ethoxylated soybean oil and ethoxylated soybean can be obtained by ethoxylating soybean oil or the saturated and/or unsaturated fatty acids obtained from soybean oil with the ethylene oxide, poly(ethylene oxide) or poly(ethylene glycol).

For example, an ethoxylated soybean can be prepared in accordance with the above-described process for preparing ethoxylated soybean oil.

The ethoxylated soybean oil or ethoxylated soybean contains from 5 to 200 ethyleneoxy groups; preferably from 10 to 150 ethyleneoxy groups; even more preferably from 15 to 100 ethyleneoxy groups.

The ethoxylated soybean oil or ethoxylated soybean contains from 20 to 80 ethyleneoxy groups; preferably it contains from 25 to 60 ethyleneoxy groups. The ethoxylated soybean oil or ethoxylated soybean contains 40 ethyleneoxy groups.

Advantageously, the ethoxylated soybean oil or ethoxylated soybean contains from 30 to 45 ethyleneoxy groups.

By ethoxylated soybean containing, for example, 40 ethyleneoxy groups (an ethyleneoxy group derives from ethylene oxide), we mean a product obtained by reacting 1 mole of soybean oil [the fatty acid composition of soybean oil was illustrated above, by way of example] with 40 moles of ethylene oxide using techniques, apparatuses and operating conditions known to the persons skilled in the art. In the context of the present invention and hereinafter we shall make reference in general to “ethoxylated soybean oil” or “ethoxylated soybean” to indicate one or more of the above-mentioned embodiments, having a variable number of ethyleneoxy groups, without any limitation but solely for the purpose of simplifying the present description.

The emulsifying composition comprises or, alternatively, consists of a soy derivative selected from the group comprising or, alternatively, consisting of (a3) at least one fatty acid obtained from soybean oil, in association with at least one vegetable olein (b). For example, the composition can comprise or consist of: (a3)+(b1); or (a3)+(b2); or (a3)+(b3); or (a3)+(b4); or (a3)+(b5); or (a3)+(b6), in a ratio by weight comprised from 1:10 to 10:1, preferably comprised from 1:5 to 5:1, for example 1:1.

The soybean fatty acid can be obtained by means of a process of hydrolysis. The hydrolysis of soybean oil triglycerides produces glycerol (or glycerine) and the respective free fatty acids (saturated, monounsaturated and polyunsaturated) such as alpha-linolenic acid, or linolenic acid, or linoleic acid, or oleic acid, or stearic acid, or palmitic acid or a mixture thereof. The mixture can comprise 0-10% by weight of alpha-linolenic acid (C-18:3), preferably from 0 to 5%; 0-70% by weight of linoleic acid (C-18:2), preferably from 40 to 60%; and 0-55% by weight of oleic acid (C-18:1), preferably from 15 to 40%.

In another preferred embodiment, the fatty acid can be a mixture as described above which further comprises saturated fatty acids such as stearic acid, from 0 to 10% by weight, preferably from 3 to 7% and/or palmitic acid, from 0 to 15% by weight, preferably from 5 to 10%.

The emulsifying composition comprises or, alternatively, consists of a soy derivative selected from the group comprising or, alternatively, consisting of (a4) at least one ethoxylated fatty acid, preferably obtained from soybean oil, in association with at least one vegetable olein (b). For example, the composition can comprise or consist of: (a4)+(b1); or (a4)+(b2); or (a4)+(b3); or (a4)+(b4); or (a4)+(b5); or (a4)+(b6), in a ratio by weight comprised from 1:10 to 10:1, preferably comprised from 1:5 a 5:1, for example 1:1.

Said at least one ethoxylated fatty acid is preferably obtained from soybean oil, but can also be obtained from another vegetable oil, such as, for example, olive oil or linseed oil or rapeseed oil or corn oil or peanut oil or sunflower oil or palm oil.

The ethoxylated fatty acid obtained from soybean oil is obtained by ethoxylating alpha-linolenic acid, or linolenic acid, or linoleic acid, or oleic acid, or stearic acid, or palmitic acid or a mixture thereof. The mixture subjected to ethoxylation can comprise 0-10% by weight of alpha-linolenic acid (0-18:3), preferably 0 to 5%; 0-70% by weight of linoleic acid (C-18:2), preferably 40 to 60%; and 0-55% by weight of oleic acid (C-18:1), preferably 15 to 40%.

In another preferred embodiment, the mixture subjected to ethoxylation can be a mixture as described above which further comprises saturated fatty acids such as stearic acid, from 0 to 10% by weight, preferably from 3 to 7%, and/or palmitic acid, from 0 to 15% by weight, preferably from 5 to 10%.

The ethoxylation can be carried out on a triglyceride, a saturated fat, a monounsaturated fat and/or a polyunsaturated fat. The degree of ethoxylation varies according to the operating conditions of temperature, pressure, solvent and catalyst. Therefore, the fatty acids obtained from soybean oil, using known chemical processes and apparatuses, are ethoxylated to yield ethoxylated fatty acids of soybean oil.

In a preferred embodiment, the ethoxylated soybean oil fatty acid contains from 5 to 200 ethyleneoxy groups; preferably from 10 to 150 ethyleneoxy groups; even more preferably from 15 to 100 ethyleneoxy groups.

In a preferred embodiment, the ethoxylated soybean oil fatty acid contains from 20 to 80 ethyleneoxy groups; preferably from 25 to 60 ethyleneoxy groups; even more preferably from 30 to 50 ethyleneoxy groups. Advantageously, the ethoxylated soybean oil fatty acid contains from 30 to 45 ethyleneoxy groups, for example 40.

By ethoxylated soybean oil fatty acid containing, for example, 15 ethyleneoxy groups (an ethyleneoxy group derives from ethylene oxide), we mean a product obtained by reacting 1 mole of a single fatty acid or mixture of fatty acids [the composition of soybean oil has been illustrated in the present description, by way of example] with 15 moles of ethylene oxide using techniques, apparatuses and operating conditions known to the persons skilled in the art. In the context of the present invention and hereinafter we shall make reference in general to “an ethoxylated soybean oil fatty acid” to indicate one or more of the above-mentioned embodiments, having a variable number of ethyleneoxy groups, without any limitation but solely for the purpose of simplifying the present description.

The emulsifying composition comprises or, alternatively, consists of a soy derivative selected from the group comprising or, alternatively, consisting of mixtures (a5), in association with at least one vegetable olein (b). For example, the composition can comprise or consist of: (a5)+(b1); or (a5)+(b2); or (a5)+(b3); or (a5)+(b4); or (a5)+(b5); or (a5)+(b6), in a ratio by weight comprised from 1:10 to 10:1, preferably comprised from 1:5 to 5:1, for example 1:1.

The emulsifier comprises or, alternatively, consists of a soy derivative selected from the group comprising or, alternatively, consisting of a mixture (a5)=(a0)+(a1)+(a2), preferably in a ratio by weight of 1:1:1, in association with at least one vegetable olein (b), as set forth above.

The emulsifier comprises or, alternatively, consists of a soy derivative selected from the group comprising or, alternatively, consisting of a mixture (a5)=(a0)+(a1) or (a5)=(a1)+(a2), preferably in a ratio by weight of 1:1, in association with at least one vegetable olein (b), as set forth above.

Said at least one vegetable olein or the vegetable oleins (b) are selected from the group comprising or, alternatively, consisting of (b1) oleic acid, (b2) linoleic acid, (b3) linolenic or alpha-linolenic acid, (b4) a monoglyceride of oleic acid and/or a diglyceride of oleic acid and/or a triglyceride of oleic acid [(C₁₇H₃₃COO)₃C₃H₅] (also known as triolein), (b5) a vegetable oil or (b6) mixtures thereof.

Said at least one vegetable olein or vegetable oleins (b) comprise or, alternatively, consist of (b1) oleic acid (C18:1) in an amount comprised from 70 to 99% by weight, preferably from 80 to 95% by weight.

Preferably, the emulsifying composition comprises a soy derivative (a) selected from the group consisting of an ethoxylated soybean oil and/or ethoxylated soybean, at least one ethoxylated fatty acid obtained from soybean oil, or a mixture thereof; and at least one vegetable olein (b) selected from the group consisting of an oleic acid, a linoleic acid, a monoglyceride of oleic acid, a diglyceride of oleic acid, a triglyceride of oleic acid, or a mixture thereof.

Preferably, the emulsifying composition comprises a soy derivative (a) selected from the group consisting of an ethoxylated soybean oil and/or ethoxylated soybean; and at least one vegetable olein (b) selected from the group consisting of an oleic acid, a linoleic acid, or a mixture thereof.

Said at least one vegetable olein or vegetable oleins (b) comprise or, alternatively, consist of a mixture between (b1) oleic acid (C18:1), in an amount comprised from 70 to 99% by weight, and (b2) linoleic acid (018:2), in an amount equal to or less than 30% by weight; preferably (b1) the oleic acid (C18:1) is present in an amount comprised from 75 to 90% by weight and (b2) the linoleic acid (C18:2) is present in an amount of less than 25% by weight; even more preferably (b1) the oleic acid (C18:1) is present in an amount comprised from 80 to 85% by weight and (b2) the linoleic acid (C18:2) is present in an amount comprised from 10 to 20% by weight (the amounts by weight are relative to the total weight of the vegetable olein). The vegetable olein or vegetable oleins (b), as described above, can further comprise some saturated fatty acids with a number of carbon atoms comprised from C10 to C18, in an amount of less than 15% by weight, preferably in an amount comprised from 5 to 10% by weight.

The olein can be a mixture comprising 5-30% by weight of alpha-linolenic acid (C-18:3), preferably 10 to 20%; 30-70% by weight of linoleic acid (C-18:2), preferably 40 to 60%; and 10-55% by weight of oleic acid (C-18:1), preferably 20 to 40%. Optionally, this mixture can further comprise saturated fatty acids such as stearic acid, from 1 to 10% by weight, preferably from 3 to 7%, and palmitic acid, from 1 to 15% by weight, preferably from 5 to 10%.

In one embodiment, a palm olein has a composition of the type: C12:0=2-3%, C14:0=0.5-1%, C16:0=4-5%, C18:0=2-3%, C18:1=70-80%, C18:2=10-15%, other substances approximately 1%.

In one embodiment, a sunflower olein has a composition of the type: C16:0=5-15%, C18:0=2-8%, C18:1=20-35%, C18:2=45-70%, C18:3=0-7%.

In one embodiment, another vegetable olein can have the following composition: acids with a number of carbon atoms equal to or less than C14=2-3%, C16:0=4-5%, C18:0=1-2%, C18:1=75-80%, C18:2=10-11%.

In one embodiment, another vegetable olein can have the following composition: C18:0=less than 15%, C18:1=greater than 75%, C18:2=less than 15%, other substances less than 1%.

Said at least one vegetable olein or vegetable oleins (b) comprise or, alternatively, consist of (b4) a monoglyceride of oleic acid and/or a diglyceride of oleic acid and/or a triglyceride of oleic acid (trioleate or glyceryl trioleate).

Said at least one vegetable olein or vegetable oleins (b) comprise or, alternatively, consist of a vegetable oil. The vegetable oil (b5) can be selected from the group comprising or, alternatively, consisting of olive oil, linseed oil, rapeseed oil, peanut oil, corn oil, palm oil, sunflower oil and soybean oil.

Preferably, the vegetable oil (b5) selected is olive oil and/or palm oil. When the soy derivative comprises or, alternatively, consists of (a1) a soybean oil, said vegetable oil (b5) is selected from the group comprising or, alternatively, consisting of olive oil, linseed oil, rapeseed oil, peanut oil, corn oil, palm oil and sunflower oil. Preferably, the vegetable oil (b5) selected is olive oil and/or palm oil.

When the soy derivative comprises or, alternatively, consists of (a3) stearic acid and/or palmitic acid, said vegetable oil (b) comprises or, alternatively, consists of (b1), or (b2), or (b3).

In another preferred embodiment, said at least one vegetable olein or vegetable oleins (b) comprise or, alternatively, consist of a mixture (b6) which comprises or, alternatively, consists of a vegetable oil (b5) and an oleic acid (b1) in a ratio by weight comprised from 1:4 to 4:1, preferably from 1:3 to 3:1, even more preferably in a ratio by weight of 1:1. Preferably, the oleic acid is selected from among products having an oleic acid concentration greater than 70% by weight, preferably greater than 90% by weight.

In the context of the present invention and hereinafter we shall make reference in general to “olein or oleins” to indicate one or more of the above-mentioned embodiments without any limitation but solely for the purpose of simplifying the present description.

The determination of the fatty acid composition can be carried out by gas chromatography, for example using the method NGD C 42-76, whereas the determination of the triglycerides in the vegetable oils is carried out by high-resolution chromatography (HPLC), for example using the method NGD C 45-91:22024 (1992).

The Applicant has found that using an emulsifying composition comprising or, alternatively, consisting of a soy derivative (a) selected from the group comprising or, alternatively, consisting of (a0), (a1), (a2), (a3), (a4) and (a5), in association with said at least one vegetable olein or vegetable oleins (b) selected from the group comprising or, alternatively, consisting of (b1) an oleic acid, (b2) a linoleic acid, (b3) a linolenic or alpha-linolenic acid, (b4) a mono-, and/or di-, and/or triglyceride of oleic acid, (b5) a vegetable oil or (b6) a mixture thereof in a process for preparing an animal feed containing nutritive substances in liquid, powder or granular form makes it possible to obtain the following advantages:

(i) increasing the output in tons per hour in plants that produce feeds in solid form, for example in the form of cubes or pellets; the increase in output is estimated to range from 5 to 30%, preferably from 10 to 20% and is generally equal to approximately 12-15% (compared to preparing a same type of feed prepared, under the same operating conditions, without the emulsifier of the present invention) depending on the operating conditions, apparatuses and type of substances making up the animal feed;
(ii) improving the pellet durability index (PDI); preferably, the improvement in the PDI is comprised from 2 to 6% (compared to the same type of feed prepared, under the same operating conditions, without the emulsifier of the present invention);
(iii) reducing the consumption of electricity expressed in amperes per hour; preferably, the reduction is comprised from 2 to 6% (compared to the same type of feed prepared, under the same operating conditions, without the emulsifier of the present invention);
(iv) reducing the amount of dust that is produced and found in the animal feed in solid form, for example in the form of cubes or pellets;
(v) assuring less wear on the equipment and the possibility of better controlling the production temperature (° C.); preferably, the reduction in temperature is comprised from 2 to 6° C. (compared to the same type of feed prepared, under the same operating conditions, without the emulsifying composition of the present invention).

The emulsifying composition of the present invention has valid application as a technological and/or nutritional additive for preparing an animal feed. In the context of the present invention, animal feed means, by way of non-restrictive example, a feed for pigs, aquaculture, fishes, poultry species, e.g. chickens and turkeys, ruminants, e.g. cattle and calves, sheep, goats and rabbits at any stage of growth.

The present invention also relates to an animal feed, preferably a dry feed in the form of flakes or granules or pellets. A dry feed is in any case a feed which, at the end of its preparation, contains a water content comprised from 5 to 20%, preferably from 10 to 15%, even more preferably 12% (at a temperature of 25° C. and pressure of 1 atmosphere). The feed of the present invention contains the emulsifying composition as disclosed above. The emulsifying composition comprises or, alternatively, consists of a soy derivative (a) selected from the group comprising or, alternatively, consisting of (a0), (a1), (a2), (a3), (a4) and (a5), in association with said at least one vegetable olein or vegetable oleins (b) selected from the group comprising or, alternatively, consisting of (b1) an oleic acid, (b2) a linoleic acid, (b3) a linolenic or alpha-linolenic acid, (b4) a mono-, and/or di-, and/or triglyceride of oleic acid, (b5) a vegetable oil or (b6) a mixture thereof.

The present invention also relates to a process for preparing said feed.

In the feed production process use is made of an emulsifying composition of the present invention. Each single soy derivative (a) selected from among (a0), (a1), (a2), (a3), (a4) and (a5) and/or each single olein (b) selected from among (b1), (b2), (b3), (b4), (b5) and (b6) can be mixed together in the required amounts so as to form the emulsifying composition and then said composition is added to the liquid or solid nutritive components/substances or to the meals which form the feed. Alternatively, each single soy derivative (a) selected from among (a0), (a1), (a2), (a3), (a4) and (a5) and/or each single olein (b) selected from among (b1), (b2), (b3), (b4), (b5) and (b6) can be separately added to the liquid or solid nutritive components/substances or to the meals which form the feed and, therefore, they can be added individually to the liquid or solid components or to the meals which form the feed.

If the emulsifying composition and/or the single soy derivatives (a) and/or the single vegetable oleins (b) are in a solid state at room temperature (25° C. and 1 atmosphere) due to their high molecular weight, a preliminary heating step is envisaged in order to turn them into a liquid state to facilitate their use.

The soy derivative (a) selected from among (a0), (a1), (a2), (a3), (a4) and (a5) and/or said at least one vegetable olein (b) selected from among (b1), (b2), (b3), (b4), (b5) and (b6) (first mixed together to yield the emulsifying composition or, alternatively, kept separate from each other) can be added directly to the nutritive substances in liquid, powder or granular form or to the meals or other solid components of the animal feed.

Alternatively, the soy derivative (a) selected from among (a0), (a1), (a2), (a3), (a4) and (a5) and/or said at least one vegetable olein (b) selected from among (b1), (b2), (b3), (b4), (b5) and (b6) (first mixed together to yield the emulsifying composition or, alternatively, kept separate from each other) can optionally be dissolved or suspended in water and/or applied on a substrate or carrier or added to a liquid and/or solid vehicle, before being added to the nutritive substances in liquid, powder or granular form or to the meals or other solid components of the animal feed.

The animal feed can contain a hydrophobic component that is liquid or solid at room temperature, such as, for example, an animal and/or vegetable lipid, an oil, preferably a vegetable oil, a liquid and/or solid fat, preferably an animal fat.

In a first case, said hydrophobic component first has the emulsifying composition comprising or, alternatively, consisting of at least one soy derivative (a) selected from the group comprising or, alternatively, consisting of (a0), (a1), (a2), (a3), (a4) and (a5) and/or said at least one vegetable olein (b) selected from the group comprising or, alternatively, consisting of (b1), (b2), (b3), (b4), (b5) and (b6) added to it to yield an intermediate mixture consisting of the hydrophobic component and emulsifier. Subsequently, said intermediate mixture has the nutritive substances in liquid, powder or granular form or the meals or other solid components of the animal feed or a mixture of two or more of these components added to it to yield the feed. A variant of this first case is represented by the fact that the soy derivative (a) selected from among (a0), (a1), (a2), (a3), (a4) and (a5) and/or said olein (b) selected from among (b1), (b2), (b3), (b4), (b5) and (b6) can be added individually and separately from each other to the hydrophobic component to yield the intermediate mixture consisting of the hydrophobic component and one or more soy derivatives (a) and/or one or more oleins (b).

In a second case, said hydrophobic component first has the nutritive substances in liquid, powder or granular form or the meals or other solid components of the animal feed or a mixture of two or more of these components added to it to yield the intermediate mixture consisting of said hydrophobic component and said nutritive substances. Subsequently, said intermediate mixture has the emulsifying composition comprising or, alternatively, consisting of at least one soy derivative (a) selected from the group comprising or, alternatively, consisting of (a0), (a1), (a2), (a3), (a4) and (a5) and/or said at least one vegetable olein (b) selected from the group comprising or, alternatively, consisting of (b1), (b2), (b3), (b4), (b5) and (b6)-added to it to yield a mixture to yield a feed. A variant of this second case is represented by the fact that said intermediate mixture has the soy derivative (a) selected from among (a0), (a1), (a2), (a3), (a4) and (a5) and/or said olein (b) selected from among (b1), (b2), (b3), (b4), (b5) and (b6) added to it to yield a feed mixture.

The hydrophobic component can be liquid or solid at room temperature (25° C. and 1 atmosphere) and can be, for example, an animal and/or vegetable lipid, an oil, preferably a vegetable oil, a liquid and/or solid fat, preferably an animal fat. If the hydrophobic component is in a solid state, it is heated to render it liquid.

The hydrophobic component in a liquid state (or, if solid, after a heating step to render it liquid) can be added, for example, to said components in liquid or solid or granular or powder form or to the meals, or part of them, in order to produce a solid powdery or granular mixture before adding the emulsifying composition comprising or, alternatively, consisting of at least one soy derivative (a) selected from the group comprising or, alternatively, consisting of (a0), (a1), (a2), (a3), (a4) and (a5) and said at least one vegetable olein (b) selected from the group comprising or, alternatively, consisting of (b1), (b2), (b3), (b4), (b5) and (b6) to yield a feed.

For example, the industrial preparation of an animal feed can entail preparing a premixture containing, for example, mineral salts, vitamins, flavourings and other substances commonly used by the person skilled in the art. Depending on the type of feed, other components can also be added to the premixture, namely, cereals, barley, corn, oats and rice, vegetable proteins, for example proteins obtained from soybeans or sunflowers, or other proteins commonly used by the person skilled in the art. The premixture subsequently has an emulsifying composition which comprises or, alternatively, consists of at least one soy derivative (a) selected from the group comprising or, alternatively, consisting of (a0), (a1), (a2), (a3), (a4) and (a5) and said at least one vegetable olein (b) selected from the group comprising or, alternatively, consisting of (b1), (b2), (b3), (b4), (b5) and (b6) (first mixed together to yield the emulsifying composition or, alternatively, kept separate from each other) added to it to yield a feed.

For example, the emulsifying composition comprising or, alternatively, consisting of at least one soy derivative (a) selected from the group comprising or, alternatively, consisting of (a0), (a1), (a2), (a3), (a4) and (a5) and said at least one vegetable olein (b) selected from the group comprising or, alternatively, consisting of (b1), (b2), (b3), (b4), (b5) and (b6) can be optionally dissolved or suspended in water and/or applied on a substrate or carrier or added to a liquid and/or solid vehicle, such as, for example, cereals, starch or mineral salts in order to form a premixture. Subsequently, the hydrophobic component in a liquid state can be added to said premixture. If said hydrophobic component is in a solid state at room temperature, a heating step is envisaged.

The hydrophobic component which is liquid or solid at room temperature can be, for example, an animal and/or vegetable lipid, an oil, preferably a vegetable oil, a liquid and/or solid fat, preferably an animal fat. After complete mixing, a composition is obtained whose consistency will depend on the physical state and amounts used of the individual components.

For example, each single soy derivative (a) selected from the group comprising or, alternatively, consisting of (a0), (a1), (a2), (a3), (a4) and (a5) and/or each vegetable olein (b) selected from the group comprising or, alternatively, consisting of (b1), (b2), (b3), (b4), (b5) and (b6) can be optionally dissolved or suspended in water and/or applied on a substrate or carrier or added to a liquid and/or solid vehicle, such as, for example, cereals, starch or mineral salts in order to form a premixture. Subsequently, the hydrophobic component in a liquid state can be added to said premixture. If said hydrophobic component is in a solid state at room temperature, a heating step is envisaged.

The liquid or solid hydrophobic component at room temperature can be, for example, an animal and/or vegetable lipid, an oil, preferably a vegetable oil, a liquid and/or solid fat, preferably an animal fat. After complete mixing, a composition is obtained whose consistency will depend on the physical state and amounts used of the individual components.

The emulsifying composition of the present invention can comprise said soy derivative (a) and said vegetable olein (b) in a ratio by weight comprised from 1:5 to 5:1, preferably from 1:3 to 3:1, even more preferably 1:1.

The animal feed of the present invention can comprise said emulsifying composition in an amount comprised from 0.1 Kg to 1 Kg/ton of feed, preferably from 0.4 to 0.8 Kg/ton of feed. Advantageously, 0.5 Kg/ton of feed (0.05%).

The animal feed of the present invention can comprise:
said at least one olein in an amount comprised from 1 Kg to 10 Kg/ton of feed, preferably from 2 Kg to 5 Kg/ton of feed,
a hydrophobic component as described above in an amount comprised from 1 to 12 Kg/100 Kg of feed, preferably 10 Kg/100 Kg of feed,
water in an amount comprised from 0.5 Kg to 1 Kg/100 Kg of feed.

The animal feed of the present invention can be subjected to a pelletting or extrusion step to yield a feed with variable dimensions typical of animal feeds in pellets.

The present invention relates to a process for preparing a feed, as described above, wherein said process comprises at least one step in which said emulsifying composition, as described above, is added directly to the nutritive substances in liquid, powder or granular form or, optionally, to other solid components of the animal feed; or, alternatively, said emulsifying composition, as described above, is first dissolved in water or suspended in water or added to a carrier and then subsequently added to the nutritive substances in liquid, powder or granular form of the animal feed.

Preferably, in said process said soy derivative (a) and said at least one vegetable olein (b), can be added, separately from each other or after being mixed to yield said emulsifying composition, to the nutritive substances in liquid, powder or granular form of the animal feed.

Preferably, in said process said soy derivative (a) and said at least one vegetable olein (b), can be added, separately from each other or after being mixed to yield said emulsifying composition, to a hydrophobic component selected from the group comprising oils, fats, lipids, saturated and/or unsaturated fatty acids, triglycerides and mixtures thereof, all of the above being of animal or vegetable origin and having a melting point above 5° C., preferably a melting point comprised from 30° C. to 80° C.

The present invention will now be described with the aid of several examples, which are given solely for illustrative purposes and therefore do not limit the scope of the present invention.

### EXAMPLES

In a plant for preparing a chicken feed in granular or powder form, of the type known to the person skilled in the art, the following feed was prepared. In a container provided with mixing means, heating means, water filling means and means for maintaining humidity, 50 Kg of corn, 18 Kg of soy, 12 Kg of sunflower and 10 Kg of barley, 4 Kg of sugar cane molasses and 6 Kg of a mixture of calcium carbonate, sodium chloride, vitamins and mineral salts were added in sequence to yield a powder mixture. Afterwards, 10 Kg of a hydrophobic component consisting in an animal fat were added. Said mixture was maintained under stirring at room temperature (25° C. and 1 atmosphere). Subsequently, the liquid components and 0.5 Kg of water/100 Kg of feed were added. After stirring, said emulsifier and said at least one olein in accordance with one of the formulations F1-F4 as specified below were added. At the end of mixing, a powder or granular mixture was obtained and then subjected to a pelletting step to yield a pellet of dimensions known to the persons skilled in the art.

### List of the Tested Formulations (F):

Ethoxylated Soybean Oil or Ethoxylated Soybean (a2)—F1, F2
F1: ethoxylated soybean oil (a2).
F2: ethoxylated soybean (a2).
   Vegetable oleins (b1) and (b1+b2)—F3, F4
F3: Oleic acid (b1).
F4: Oleic acid 80%+Linoleic acid 20% (b1+b2).

The Applicant tested the formulations specified in Table 1 in the preparation of an animal feed in pellets for chickens, turkeys, pigs and ruminants (dairy cows). An example of a feed for dairy cows is given in Table 2. An example of a feed for pigs is given in Table 3. An example of a feed for chickens (first period) is shown in Table 4. An example of a feed for chickens (third period) is shown in Table 5. An example of a feed for turkeys (first period) is shown in Table 6.

During the production of the various animal feeds, the following parameters were monitored:

i) the temperature (° C.) of the pellet leaving the extruder.
ii) the consumption of energy (Amperes) per tons/hour of feed produced.
iii) the hourly output expressed in tons/hour.
iv) the final humidity value (% humidity) found in the pellet.
v) the pellet durability index (P.D.I.) value, which expresses the hardness/consistency of the pellet. The P.D.I. value that depends on the type of feed that is prepared. The person skilled in the art is aware of the minimum and maximum PDI value which characterizes a feed in pellets for chickens, turkeys, pigs and calves.

Tests 1 and 2, illustrated in Table 7, show only part of the experimentation conducted by the Applicant.

Tests 1 and 2 were conducted under the same operating conditions in a plant for preparing a chicken feed having the ingredients specified above.

Practically speaking, in an industrial plant for producing a chicken feed (4) and (5), as described above, the parameters specified above in items (i)-(v) were recorded.

The parameters in the “chicken feed” column shown for each test 1-2 (see second column from the left) were recorded without the use of any of the formulations of the present invention.

The parameters in the “formulation F1” column shown for test 1 (see third column from the left) were recorded with the use of the formulation F1. The formulation F1 was used at a concentration of 0.5 Kg/ton of feed.

The parameters in the “formulation F1+F3” column shown for test 1 (see fourth column from the left) were recorded with the use of the formulation F1+F3 of the present invention. The formulation F1+F3 (1:1 ratio by weight) was used at a concentration of 0.5 Kg/ton of feed.

The parameters in the “formulation F1+F4” column shown for test 1 (see fifth column from the left) were recorded with the use of the formulation F1+F4 of the present invention. The formulation F1+F4 (1:1 ratio by weight) was used at a concentration of 0.5 Kg/ton of feed.

The parameters in the “formulation F2” column for test 2 (see third column from the left) were recorded with the use of the formulation F2. The formulation F2 was used at a concentration of 0.5 Kg/ton of feed.

The parameters in the “formulation F2+F3” column shown for test 2 (see fourth column from the left) were recorded with the use of the formulation F2+F3 of the present invention. The formulation F2+F3 (1:1 ratio by weight) was used at a concentration of 0.5 Kg/ton of feed.

The parameters in the “formulation F2+F4” column shown for test 2 (see fifth column from the left) were recorded with the use of the formulation F2+F4 of the present invention. The formulation F2+F4 (1:1 ratio by weight) was used at a concentration of 0.5 Kg/ton of feed.

The parameters in the “oleins F3” and “oleins F4” column shown for each of tests 1-2 (see sixth and seventh column from the left) were recorded with the use of the formulations F3 and F4. The oleins F3 and F4 were used at a concentration of 5 Kg/ton of feed.

For example, considering test 1 carried out without the use of a formulation of the present invention (second column from the left) the hourly output in tons/hour (briefly, tons/hour) is approximately 20-21 tons/hour, whereas the PDI is approximately 88-89. With the use of a formulation F1, the hourly output rises to 22-23 tons/hour and the PDI to 89-90. Surprisingly, the formulation of the present invention F1+F3 brings the hourly output to 26-27 and the PDI to 94-95. Whereas the formulation F1+F4 provides an hourly output value of 28-29 and a PDI value of 93-94. The increase in the hourly output and PDI value are considerable if compared with the values shown in the second and third columns from the left. The same trend is present in test 2. Therefore, tests 1-2 carried out by the Applicant are in agreement in demonstrating that the formulations of the present invention are capable of:

(i) increasing the output expressed in tons per hour in plants that produce animal feeds in solid form, for example in the form of pellets,
(ii) improving the pellet durability index (PDI),
(iii) reducing the consumption of electricity expressed in amperes/hour,
(iv) reducing the amount of dust that is produced and remains in the animal feed in solid form, for example in the form of pellets.
(v) assuring less wear on the equipment and the possibility of better controlling the production temperatures.

The Applicant further verified the use of a formulation consisting only of oleins, for example the formulations F3 and F4 (without the presence of the emulsifier of the present invention).

The Applicant conducted a trial using 0.5% by weight of oleic acid (5 Kg/ton of feed) and a mixture of 80% oleic acid and 20% linoleic acid in an amount of 0.5% by weight, relative to the total weight of the mixture (5 Kg/ton of feed). The data regarding the parameters measured are shown in Table 7—test 1 and test 2 (sixth and seventh column from the left). The results obtained show that the values of the parameters are comparable only to those obtained without the use of any formulation of the present invention (see in Table 7—test 1 and test 2, second and third column from the left), notwithstanding that the concentration of oleins used was 10 times greater than the concentrations of the tested formulations of the present invention. “DM” indicates the amount of dry matter.

TABLE 1

| FORMULATIONS | Chickens | Turkeys | Pigs | Dairy cows |
|---|---|---|---|---|
| F1 | 100% | 100% | 100% | 100% |
| F1 + F3 | 50%-50% | 50%-50% | 50%-50% | 50%-50% |
| F1 + F4 | 50%-50% | 50%-50% | 50%-50% | 50%-50% |
| F2 | 100% | 100% | 100% | 100% |
| F2 + F3 | 50%-50% | 50%-50% | 50%-50% | 50%-50% |
| F2 + F4 | 50%-50% | 50%-50% | 50%-50% | 50%-50% |

TABLE 2
Feed for dairy cows

| INGREDIENTS | KG | % |
|---|---|---|
| CORN MEAL | 50.00 | 50.00% |
| SOYBEAN | 15.00 | 15.00% |
| SUNFLOWER | 15.00 | 15.00% |
| BARLEY | 10.00 | 10.00% |
| SUGAR CANE MOLASSES | 4.00 | 4.00% |
| CALCIUM CARBONATE | 2.00 | 2.00% |
| SODIUM BICARBONATE | 1.50 | 1.50% |
| SODIUM CHLORIDE | 0.75 | 0.75% |
| DICALCIUM PHOSPHATE | 0.75 | 0.75% |
| VITAMINS | 0.50 | 0.50% |
| MAGNESIUM OXIDE | 0.50 | 0.50% |
| Totals | 100.00 | 100.00% |
| | 88.00 DM | (Humidity 12.00%) |

TABLE 3
Feeds for pigs

| INGREDIENTS | KG | % |
|---|---|---|
| SOFT WHEAT | 30.00 | 30.00% |
| COOKED WHEAT | 20.00 | 20.00% |
| FLAKED BARLEY | 16.00 | 16.00% |
| WHEY | 9.00 | 9.00% |
| FLAKED CORN | 9.00 | 9.00% |
| HERRINGS | 7.00 | 7.00% |
| SOYBEAN OIL | 3.90 | 3.90% |
| POTATO | 2.50 | 2.50% |
| DICALCIUM PHOSPHATE | 0.50 | 0.50% |
| ACIDIFIER | 0.50 | 0.50% |
| CALCIUM CARBONATE | 0.50 | 0.50% |
| L-LYSINE HCL | 0.50 | 0.50% |
| L-THREONINE | 0.30 | 0.30% |
| SODIUM CHLORIDE | 0.20 | 0.20% |
| DL-METHIONINE | 0.06 | 0.06% |
| L-TRYPTOPHAN | 0.04 | 0.04% |
| Totals | 100.00 | 100.00% |
| | 89.50 DM | (Humidity 10.5%) |

TABLE 4
Feed for chickens (first period)

| INGREDIENTS | Kg | % |
|---|---|---|
| CORN | 60.00 | 60.00 |
| SOYBEAN | 35.000 | 35.00 |
| DICALCIUM PHOSPHATE | 2.00 | 2.00 |
| SOYBEAN OIL | 1.20 | 1.20 |
| CALCIUM CARBONATE | 0.80 | 0.80 |
| TRACE ELEMENTS | 0.30 | 0.30 |
| VITAMINS | 0.30 | 0.30 |
| SODIUM BICARBONATE | 0.20 | 0.20 |
| SODIUM CHLORIDE | 0.20 | 0.20 |
| Totals | 100.00 Kg DM | 87.30% |

TABLE 5
Feed for chickens (third period)

| INGREDIENTS | Kg | % |
|---|---|---|
| CORN | 66.00 | 66.00 |
| SOYBEAN | 25.00 | 25.00 |
| SOYBEAN OIL | 3.50 | 3.50 |
| DICALCIUM PHOSPHATE | 2.50 | 2.50 |
| CALCIUM CARBONATE | 1.20 | 1.20 |
| TRACE ELEMENTS | 0.80 | 0.80 |
| VITAMINS | 0.50 | 0.50 |
| SODIUM BICARBONATE | 0.20 | 0.20 |
| SODIUM CHLORIDE | 0.30 | 0.30 |
| Totals | 100.00 Kg DM | 87.50 |

TABLE 6
Feed for turkeys (first period)

| INGREDIENTS | Kg | % |
|---|---|---|
| SOYBEAN | 50.00 | 50.00 |
| CORN | 43.00 | 43.00 |
| DICALCIUM PHOSPHATE | 2.50 | 2.50 |
| CALCIUM CARBONATE | 1.50 | 1.50 |
| SOYBEAN OIL | 1.50 | 1.50 |
| TRACE ELEMENTS | 0.50 | 0.50 |
| VITAMINS | 0.50 | 0.50 |
| SODIUM CHLORIDE | 0.50 | 0.50 |
| Totals | 100.00 Kg DM | 87.50 |

TABLE 7
Test 1

| | Chicken | | | | | |
|---|---|---|---|---|---|---|
| Parameters | Feed | F1 | F1 + F3 | F1 + F4 | F3 | F4 |
| T ° C. | 80 ± 1 | 81 ± 1 | 83 ± 1 | 83 ± 1 | 78 ± 1 | 78 ± 1 |
| Amperes | 470 | 470 | 465 | 470 | 490 | 490 |
| Tons/hour | 20-21 | 22-23 | 26-27 | 28-29 | 21-22 | 20-21 |
| % Humidity | 11.40% | 11.60% | 11.90% | 11.90% | 11.30% | 11.50% |
| P.D.I. | 88-89 | 89-90 | 94-95 | 93-94 | 90-91 | 90-91 |
| % F | — | 0.05 | 0.05 | 0.05 | — | — |
| % Water | 0.5 | 0.5 | 0.5 | 0.5 | 0.5 | 0.5 |
| % Olein | — | — | — | — | 0.5 | 0.5 |

TABLE 7
Test 2

| | Chicken | | | | | |
|---|---|---|---|---|---|---|
| Parameters | Feed | F2 | F2 + F3 | F2 + F4 | F3 | F4 |
| T ° C. | 82 ± 1 | 82 ± 1 | 83 ± 1 | 83 ± 1 | 80 ± 1 | 81 ± 1 |
| Amperes | 480 | 480 | 475 | 470 | 500 | 510 |
| Tons/hour | 20-21 | 21-22 | 25-26 | 26-27 | 20-21 | 21-22 |
| % Humidity | 11.50% | 11.60% | 12.00% | 12.10% | 11.60% | 11.50% |
| P.D.I. | 90-91 | 91-92 | 94-95 | 93-94 | 90-91 | 89-90 |
| % F | — | 0.05 | 0.05 | 0.05 | — | — |
| % Water | 0.5 | 0.5 | 0.5 | 0.5 | 0.5 | 0.5 |
| % Olein | — | — | — | — | 0.5 | 0.5 |

TABLE A
Comparison of properties of vegetable oils (per 100 g)

| | | | Mono- | Poly- | |
|---|---|---|---|---|---|
| | Total | Saturated | unsaturated | unsaturated | Smoke |
| | fat | fats | fats | fats | point |
| Sunflower | 100 g | 11 g | 20 g | 69 g | 225° C. |
| oil | | | | | (437° F.) |
| Soybean | 100 g | 16 g | 23 g | 58 g | 257° C. |
| oil | | | | | (495° F.) |
| Olive oil | 100 g | 14 g | 73 g | 11 g | 190° C. |
| | | | | | (374° F.) |
| Corn oil | 100 g | 15 g | 30 g | 55 g | 230° C. |
| | | | | | (446° F.) |
| Peanut oil | 100 g | 17 g | 46 g | 32 g | 225° C. |
| | | | | | (437° F.) |
| Hydro- | 71 g | 23 g (34%) | 8 g (11%) | 37 g (52%) | 165° C. |
| genated | | | | | (329° F.) |
| vegetables | | | | | |
| Lard | 100 g | 39 g | 45 g | 11 g | 190° C. |
| | | | | | (374° F.) |
| Suet | 94 g | 52 g (55%) | 32 g (34%) | 3 g (3%) | 200° C. |
| | | | | | (400° F.) |
| Butter | 81 g | 51 g (63%) | 21 g (26%) | 3 g (4%) | 150° C. |
| | | | | | (302° F.) |

The Applicant also tested the formulations indicated as F7 and F8 in association (a mixture) with the vegetable oleins indicated as F3 and F4 in the preparation of an animal feed in pellets for chickens, turkeys, ruminants (dairy cows) or and pigs. The results obtained are very good and comparable to those obtained above.

Polyethylene Glycol Esters of Fatty Acids Obtained from Soybean Oil E487 (F7-F8)
F7: Polyethylene glycol esters of fatty acids obtained from soybean oil E487, in a 1:1 ratio by weight. The polyethylene glycol has a molecular weight of approximately 300 and the soybean fatty acids are: palmitic acid, approximately 10%; stearic acid, approximately 5%; oleic acid, approximately 20%; linoleic acid, approximately 55% and alpha-linolenic acid, approximately 10%.
F8: Polyethylene glycol esters of fatty acids obtained from soybean oil E487, in a 1:1 ratio by weight. The polyethylene glycol has a molecular weight of approximately 800 and the soybean fatty acids are: palmitic acid, approximately 10%; stearic acid, approximately 5%; oleic acid, approximately 20%; linoleic acid, approximately 55% and alpha-linolenic acid, approximately 10%.

1. A method for preparing animal feed containing nutritive substances in liquid, powder, or granular form comprising using an emulsifying composition comprising:
a soy derivative (a) selected from the group consisting of:
polyethylene glycol esters of fatty acids obtained from soybean oil—additive E487,
a soybean oil,
an ethoxylated soybean oil and/or ethoxylated soybean,
at least one fatty acid obtained from soybean oil,
at least one ethoxylated fatty acid obtained from soybean oil, or
a mixture thereof; and
at least one vegetable olein (b) selected from the group consisting of:
an oleic acid,
a linoleic acid,
a linolenic or alpha-linolenic acid,
a monoglyceride of oleic acid and/or a diglyceride of oleic acid and/or a triglyceride of oleic acid,
a vegetable oil, or
a mixture thereof.

2. The method according to claim 1, wherein said composition comprises:
a soy derivative (a) selected from the group consisting of:
a polyethylene glycol esters of fatty acids obtained from soybean oil—additive E487,
an ethoxylated soybean oil and/or ethoxylated soybean,
at least one ethoxylated fatty acid obtained from soybean oil, or
a mixture thereof; and
at least one vegetable olein (b) selected from the group consisting of:
an oleic acid,
a linoleic acid,
a monoglyceride of oleic acid, a diglyceride of oleic acid, a triglyceride of oleic acid, or
a mixture thereof.

3. The method according to claim 1, wherein said composition comprises:
a soy derivative (a) selected from the group consisting of:
polyethylene glycol esters of fatty acids obtained from soybean oil—additive E487,
an ethoxylated soybean oil and/or ethoxylated soybean; and
at least one vegetable olein (b) selected from the group consisting of:
an oleic acid,
a linoleic acid, or
a mixture thereof.

4. The method according to claim 1, wherein said polyethylene glycol esters of fatty acids are obtained from soybean oil—additive E487, and said ethoxylated soybean oil and/or ethoxylated soybean contain from 5 to 200 ethyleneoxy groups.

5. The method according to claim 1, wherein said at least one ethoxylated fatty acid, obtained from soybean oil, is obtained by ethoxylating alpha-linolenic acid or linolenic acid or linoleic acid or oleic acid or stearic acid or palmitic acid or mixtures thereof with ethylene oxide.

6. The method according to claim 1, wherein said at least one vegetable olein (b) comprises a ixture comprising oleic acid, in an amount comprised from 70 to 99% be weight, and linoleic acid, in an amount equal to or less than 30% by weight, relative to the total weight of the vegetable olein.

7. An animal feed containing nutritive substances in liquid, powder or granular form, wherein said feed comprises an emulsifying composition comprising:
a soy derivative (a) selected from the group consisting of:
polyethylene glycol esters of fatty acids obtained from soybean oil—additive E487,
a soybean oil,
an ethoxylated soybean oil and/or ethoxylated soybean,
at least one fatty acid obtained from soybean oil,
at least one ethoxylated fatty acid obtained from soybean oil, or
a mixture thereof; and
at least one vegetable olein (b) selected from the group consisting of:
an oleic acid,
a linoleic acid,
a linolenic or alpha-linolenic acid,
a monoglyceride of oleic acid and/or a diglyceride of oleic acid and/or a triglyceride of oleic acid,
a vegetable oil, or
a mixture thereof.

8. A process for preparing a feed according to claim 7, wherein said process comprises a step in which said emulsifying composition according to claim 1 is added directly to the nutritive substances in liquid, powder or granular form or, optionally, to other solid components of the animal feed.

9. The process according to claim 8, wherein said soy derivative (a) and said at least one vegetable olein (b) in accordance with claim 1 can be added, either separately or after first being mixed to yield said emulsifying composition, to the nutritive substances in liquid, powder or granular form of the animal feed.

10. The process according to claim 8, wherein said soy derivative (a) and said at least one vegetable olein (b) in accordance with claim 1 can be added, either separately or after first being mixed to yield said emulsifying composition, to a hydrophobic component selected from the group comprising oils, fats, lipids, saturated and/or unsaturated fatty acids, triglycerides or mixtures thereof, all of the above being an animal or vegetable origin and having a melting point about 5° C.

11. The method according to claim 4, wherein said ethoxylated soybean oil and/or ethoxylated soybean contain from 10 to 150 ethyleneoxy groups.

12. The method according to claim 4, wherein said ethoxylated soybean oil and/or ethoxylated soybean contain from 20 to 80 ethyleneoxy groups.

13. The method according to claim 1, wherein said at least one ethoxylated fatty acid, obtained from soybean oil, is obtained by ethoxylating alpha-linolenic acid or linolenic acid or linoleic acid or oleic acid or stearic acid or palmitic acid or mixtures thereof with ethylene oxide with from 10 to 150 ethyleneoxy groups.

14. The method according to claim 1, wherein said at least one ethoxylated fatty acid, obtained from soybean oil, is obtained by ethoxylating alpha-linolenic acid or linolenic acid or linoleic acid or oleic acid or stearic acid or palmitic acid or mixtures thereof with ethylene oxide with from 20 to 80 ethyleneoxy groups.

15. The method according to claim 5, wherein said at least one vegetable olein (b) comprises a mixture comprising oleic acid, in an amount comprised from 75 to 90% by weight, and linoleic acid, in an amount of less than 25% by weight, relative to the total weight of the vegetable olein.

16. The method according to claim 5, wherein said at least one vegetable olein (b) comprises a mixture comprising oleic acid, in an amount comprised from 80 to 85% by weight, and linoleic acid, in an amount comprised from 10 to 20% by weight, relative to the total weight of the vegetable olein.

17. A process for preparing a feed according to claim 7, wherein said process comprises a step in which said emulsifying composition according to claim 1 is first dissolved in water or suspended in water or added to a carrier and subsequently added to the nutritive substances in liquid, powder or granular form of the animal feed.

18. The process according to claim 8, wherein said soy derivative (a) and said at least one vegetable olein (b) in accordance with claim 1 can be added, either separately or after first being mixed to yield said emulsifying composition, to a hydrophobic component selected from the group comprising oils, fats, lipids, saturated and/or unsaturated fatty acids, triglycerides or mixtures thereof, all of the above being an animal or vegetable origin and having a melting point comprised from 30° C. to 80° C.

19. An animal feed containing nutritive substances in liquid, powder or granular form, according to claim 7 wherein said feed comprises an emulsifying composition comprising:
a soy derivative (a) selected from the group consisting of:
a polyethylene glycol esters of fatty acids obtained from soybean oil—additive E487,
an ethoxylated soybean oil and/or ethoxylated soybean,
at least one ethoxylated fatty acid obtained from soybean oil, or
a mixture thereof; and
at least one vegetable olein (b) selected from the group consisting of:
an oleic acid,
a linoleic acid,
a monoglyceride of oleic acid, a diglyceride of oleic acid, a triglyceride of oleic acid, or
a mixture thereof.

20. An animal feed containing nutritive substances in liquid, powder or granular form, according to claim 7 wherein said feed comprises an emulsifying composition comprising:
a soy derivative (a) selected from the group consisting of:
polyethylene glycol esters of fatty acids obtained from soybean oil
additive E487,
an ethoxylated soybean oil and/or ethoxylated soybean; and
at least one vegetable olein (b) selected from the group consisting of:
an oleic acid,
a linoleic acid, or
a mixture thereof.
